(19) United States
(12) Patent Application Publication
(10) Pub. No.: US 2019/0340710 A1
(43) Pub. Date: Nov. 7, 2019

(54) TRANSACTION OBJECT RESERVATION SYSTEM, METHOD, AND APPARATUS

(71) Applicant: Alibaba Group Holding Limited, Grand Cayman (KY)

(72) Inventor: Bin XUE, Zhejiang (CN)

(73) Assignee: Alibaba Group Holding Limited

(21) Appl. No.: 16/514,888

(22) Filed: Jul. 17, 2019

Related U.S. Application Data
(63) Continuation of application No. PCT/CN2018/071872, filed on Jan. 9, 2018.

(30) Foreign Application Priority Data
Jan. 20, 2017 (CN) 201710045851.1

(51) Int. Cl. G06Q 50/12; G06Q 10/02

(52) U.S. Cl. CPC G06Q 50/12; G06Q 10/02

(57) ABSTRACT

A transaction object reservation method including: receiving, by a platform server, a first reservation request sent by a client terminal; determining, according to reservation object information in the first reservation request and reservation information of an inventory, whether the reservation information of the inventory meets the first reservation request; if the reservation information of the inventory meets the first reservation request, generating a first reservation result based on the reservation object information corresponding to the first reservation request; if not, sending the first reservation request to the transaction object server and receiving the first reservation result fed back by the transaction object server; and feeding the first reservation result back to the client terminal.

### CROSS REFERENCE TO RELATED PATENT APPLICATIONS

This application claims priority to and is a continuation of PCT Patent Application No. PCT/CN2018/071872, filed on 9 Jan. 2018 and entitled “SERVICE OBJECT RESERVATION SYSTEM, METHOD AND APPARATUS,” which claims priority to Chinese Patent Application No. 201710045851.1 filed on 20 Jan. 2017 and entitled “TRANSACTION OBJECT RESERVATION SYSTEM, METHOD, AND APPARATUS,” which are both incorporated herein by reference in its entirety.

### TECHNICAL FIELD

The present disclosure relates to the field of electronic technology, and, more particularly, to transaction object reservation systems, methods, and apparatuses.

### BACKGROUND

A hotel online reservation service refers to an Internet service process of providing users with a web page or a mobile application (app) for the users to fill in hotel reservation information and submit the reservation information to the hotel, thus completing hotel room reservation.

FIG. 1 is a schematic flowchart of a reservation process according to the conventional techniques. As shown in FIG. 1, in the conventional reservation services, after a client terminal 102 submits reservation information to a platform server 104, the platform server 104 initiates a request to an agent system 106, then the agent system 106 sends the request to a channel management system 108, the channel management system 108 sends the request to a hotel Property Management System (PMS) system 110, and finally a reservation result, i.e., created order information, is returned to the client terminal 102.

Thus, there are many links in the conventional order information creation process, and any problem in any of the links will result in reservation failure, so that a reservation success rate is low. For example, it is supposed that a processing success rate of each system is 99%, and after the online reservation service system, the agent system, the channel management system, and the hotel PMS system, a total success rate is the 4th power of 99%, which is approximately equal to 96%.

In summary, at present, the subsequent order information creation process has a lot of links after the user submits the reservation information, resulting in a low reservation success rate.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

A transaction object reservation system, method, and apparatus are provided in example embodiments of the present disclosure, for solving a problem of low reservation success rate caused by many links in an order information creation process.

A transaction object reservation system provided in the example embodiments of the present disclosure includes:

a platform server configured to receive a first reservation request carrying reservation object information and sent by a client terminal; determine, according to the reservation object information and reservation information of an inventory, whether the reservation information of the inventory meets the first reservation request, wherein the reservation information of the inventory is obtained by the platform server previously initiating a second reservation request carrying the reservation object information; if the reservation information of the inventory meets the first reservation request, generate a first reservation result corresponding to the first reservation request; if not, send the first reservation request to a transaction object server to obtain a first reservation result; and feed the first reservation result back to the client terminal;

the client terminal configured to receive the reservation object information submitted by a user, and send the first reservation request to the platform server based on the reservation object information; and receive the first reservation result fed back by the platform server based on the reservation object information in the first reservation request and the reservation information of the inventory; and

the transaction object server configured to receive the second reservation request previously initiated by the platform server, and feed a second reservation result back to the platform server, wherein the second reservation result includes information about successful reservation corresponding to the second reservation request, which serves as reservation information of an initial inventory of the platform server; and receive the first reservation request initiated by the user and sent by the platform server, and feed the first reservation result back to the platform server.

A transaction object reservation method provided in the example embodiments of the present disclosure includes:

receiving, by a platform server, a first reservation request carrying reservation object information and sent by a client terminal;

determining, according to the reservation object information in the first reservation request and reservation information of an inventory, whether the reservation information of the inventory meets the first reservation request, wherein the reservation information of the inventory includes information about successful reservation obtained by the platform server after the platform server previously initiated a second reservation request carrying the reservation object information to a transaction object server;

if the reservation information of the inventory meets the first reservation request, generating a first reservation result based on the reservation object information corresponding to the first reservation request; if not, sending the first reservation request to the transaction object server and receiving the first reservation result fed back by the transaction object server; and

feeding the first reservation result back to the client terminal.

A transaction object reservation method further provided in the example embodiments of the present disclosure includes:

receiving, by a client terminal, reservation object information submitted by a user;

sending a first reservation request carrying the reservation object information to a platform server; and

receiving a first reservation result fed back by the platform server according to the reservation object information in the first reservation request and reservation information of an inventory, wherein the reservation information of the inventory includes information about successful reservation obtained by the platform server after the platform server previously initiated a second reservation request carrying the reservation object information to a transaction object server; and the first reservation result includes information about successful reservation corresponding to the first reservation request.

A platform server provided in the example embodiments of the present disclosure includes:

a receiving module configured to receive a first reservation request carrying reservation object information and sent by a client terminal;

a reservation processing module configured to determine, according to the reservation object information in the first reservation request and reservation information of an inventory, whether the reservation information of the inventory meets the first reservation request, wherein the reservation information of the inventory includes information about successful reservation obtained after a second reservation request carrying the reservation object information is previously initiated to a transaction object server by a sending module; if the reservation information of the inventory meets the first reservation request, generate a first reservation result based on the reservation object information corresponding to the first reservation request; if not, control the sending module to send the first reservation request to the transaction object server, and obtain, by the receiving module, the first reservation result fed back by the transaction object server; and

the sending module further configured to feed the first reservation result back to the client terminal.

A client terminal further provided in the example embodiments of the present disclosure includes:

a first receiving module configured to receive reservation object information submitted by a user;

a first generation module configured to generate a first reservation request carrying the reservation object information based on the reservation object information;

a sending module configured to send the first reservation request; and

a second receiving module configured to receive a first reservation result fed back by the platform server according to the reservation object information in the first reservation request and reservation information of an inventory, wherein the reservation information of the inventory includes information about successful reservation obtained by the platform server after the platform server previously initiated a second reservation request carrying the reservation object information to a transaction object server; and the first reservation result includes information about successful reservation corresponding to the first reservation request.

By using the above example embodiments, a platform server initiates a reservation request to a transaction object server outside a system in advance before a user actually initiates a reservation request to the platform server, and stores an obtained reservation result as reservation information of an initial inventory. After a reservation request actually initiated by a client terminal is received, a reservation result corresponding to the actual reservation request of the user is returned to the client terminal based on the reservation information of the local inventory. Thus, the platform server does not need to initiate a request to the transaction object server at the time when receiving the request from the client terminal, and the client terminal may obtain the reservation result returned by the platform server in time, thus improving the reservation efficiency and reservation success rate and then improving user experience.

### BRIEF DESCRIPTION OF THE DRAWINGS

In order to illustrate the technical solutions in the example embodiments of the present disclosure more clearly, the following briefly describes the accompanying drawings which aid in describing the example embodiments. Apparently, the accompanying drawings in the following description merely show some of the example embodiments of the present disclosure, and persons of ordinary skill in the art may derive other drawings from these accompanying drawings without creative efforts.

FIG. 1 is a schematic flowchart of a reservation process according to the description in the Background;

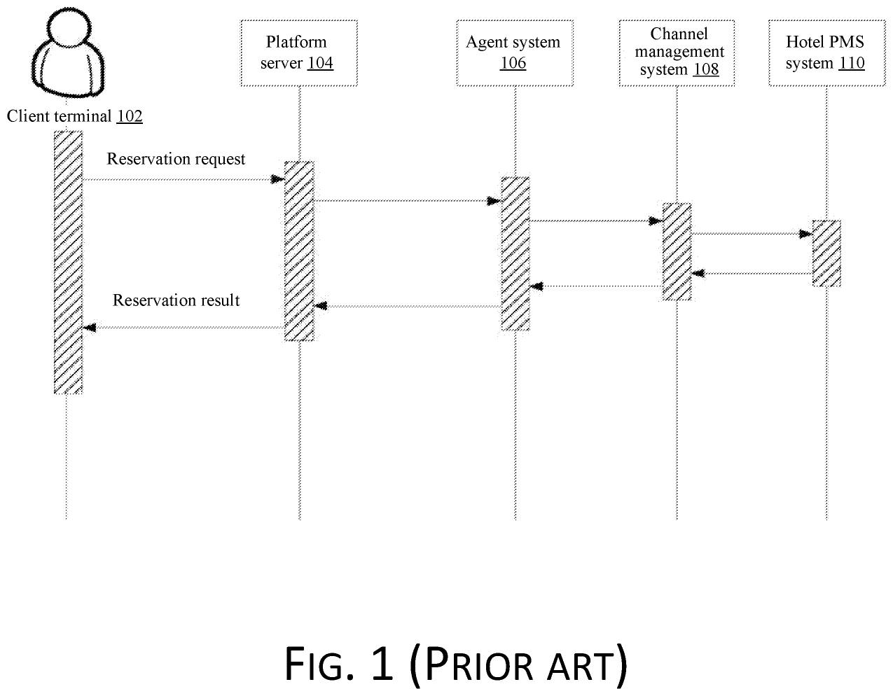

FIG. 2 is a flowchart of a transaction object reservation method according to an example embodiment of the present disclosure;

FIG. 3 is an example effect diagram of implementation of the present disclosure;

FIG. 4 is a flowchart of a transaction object reservation method according to an example embodiment of the present disclosure;

FIG. 5 is a schematic diagram of a transaction object reservation system according to an example embodiment of the present disclosure;

FIG. 6 is a schematic structural diagram of a platform server according to an example embodiment of the present disclosure; and

FIG. 7 is a schematic structural diagram of a client terminal according to an example embodiment of the present disclosure.

### DETAILED DESCRIPTION

The example embodiments of the present disclosure are mainly applicable to a scenario in which a platform server needs to send a reservation request to a transaction object server outside a system, for providing a reservation result to a client terminal user. In this scenario, according to a conventional request process, the platform server requests the reservation result from the transaction object server outside the system after receiving a reservation request actually initiated by the user, and the failure rate of the reservation request is high due to many links in the reservation process.

The solution of the present disclosure is further introduced below by taking hotel reservation as an example.

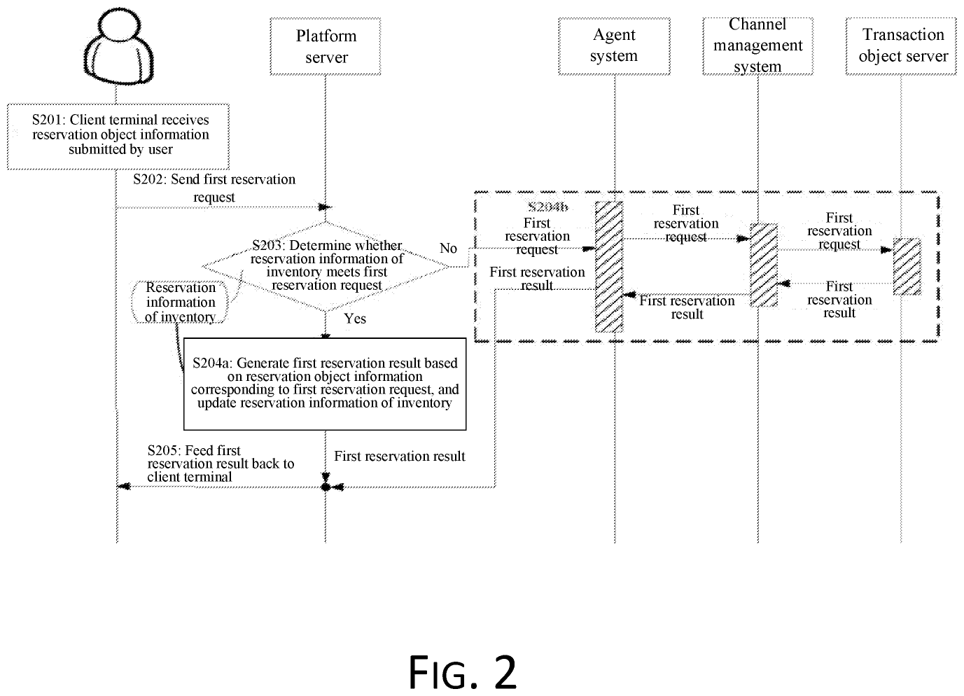

FIG. 2 is a flowchart of a transaction object reservation method according to an example embodiment of the present disclosure, including:

In S201, a client terminal receives reservation object information submitted by a user.

With respect to hotel reservation, the reservation object information submitted by the user may include information such as a hotel name and a room type.

In S202, the client terminal sends a first reservation request carrying the reservation object information to a platform server based on the received reservation object information.

Here, after the user confirms the reservation, the client terminal sends the first reservation request carrying the reservation object information selected by the user to the platform server.

In S203, the platform server determines, according to the reservation object information in the first reservation request and reservation information of an inventory, whether the reservation information of the inventory meets the first reservation request. If the reservation information of the inventory meets the first reservation request, S204a is performed; otherwise S204b is performed. The reservation information of the inventory includes information about successful reservation obtained by the platform server after the platform server previously initiated a second reservation request carrying the reservation object information to a transaction object server.

For example, the platform server initiates the second reservation request carrying the reservation object information to the transaction object server in advance according to an inventory requirement in a future reservation time period, and after the reservation succeeds, stores reservation information about successful reservation returned by the transaction object server. Then, after the reservation request actually initiated by the user is received, the stored reservation information is checked first to see whether it meets the reservation request of the user. If so, a reservation result is returned to the user directly, as shown in S204a. If not, a request further needs to be sent to the transaction object server according to the conventional process, as shown in S204b.

For example, the platform server determines, according to historical reservation data, an inventory requirement in a future reservation time period. The historical reservation data includes the reservation object provided by the transaction object server, reservation data of a reservation actually initiated by the user. The inventory requirement includes a total amount of requirements of various users for each type of reservation objects provided by the transaction object server (e.g., the number of required standard rooms, and the number of required king-size rooms); sends the second reservation request to the transaction object server according to the determined inventory requirement; and receives a second reservation result carrying the information about successful reservation returned by the transaction object server, and uses the second reservation result as the reservation information of the initial inventory.

Here, the historical reservation data may be stored in the platform server, or stored in an independent database, and the platform server initiates a query request to the database when required.

In an actual implementation, the platform server may predict inventory requirement information for each transaction object service provider in a predetermined time period according to stored historical order data r corresponding to multiple transaction object service providers (e.g., a hotel) respectively. Then, the second reservation request is sent to the transaction object server (e.g., a hotel management system of the hotel) corresponding to the transaction object service provider according to the predicted inventory requirement for the transaction object service provider.

After the platform server in advance initiates the second reservation request carrying the reservation object information to a transaction object server, a mapping relationship between the obtained information about successful reservation and service provider identifier information (e.g., the hotel name) corresponding to the transaction object server is established, and the mapping relationship is stored as the reservation information of the inventory. Then, after the user actually initiates the first reservation request, the reservation information of the inventory is searched for the information about successful reservation corresponding to the service provider identifier information according to the service provider identifier information carried in the first reservation request. Further, according to other reservation object information (the room type, and the number of rooms, e.g., 2 standard rooms) in the first reservation request, whether the information about successful reservation searched out meets the first reservation request is determined.

With respect to the request path of the platform server→the agent system→the channel management system→the transaction object server, when the platform server sends the second reservation request to the transaction object server, the second reservation request is initiated to the agent system first, the agent system initiates a request to the channel management system continuously after receiving the second reservation request, and finally the channel management system initiates a request to the transaction object server (such as the hotel management system), and returns the second reservation result returned by the transaction object server to the platform server through the agent system. The platform server stores the obtained second reservation result as the reservation information of the initial inventory, for example, records the hotel name, hotel room type, check-in time, order number, and the like of the successful reservation.

In S204a, when the reservation information of the inventory meets the first reservation request, the platform server generates the first reservation result based on the reservation object information corresponding to the first reservation request, and updates the reservation information of the inventory.

Here, the platform server searches the reservation information of the inventory to determine whether there is reservation information corresponding to the first reservation request, and generates the first reservation result corresponding to the first reservation request based on the found reservation information. For example, the reservation information of the inventory includes room information of 10 standard rooms of a chain hotel that are successfully reserved by the platform server in advance. If a standard room of the chain hotel is requested to be reserved in the first reservation request, one room is selected from the 10 standard rooms that are successfully reserved previously, and related order information (the hotel information, the room type, the check-in time, the order number, and the like) is returned to the client terminal.

For example, for some scenarios that require filling of user information to initiate a reservation, the platform server does not know actual user information during in-advance creation of an order, and therefore, the reservation may be initiated using default user information of the platform during the in-advance creation of the order, and an order information update process is initiated subsequently after an order is created for an actual user.

For example, the platform server generates the first reservation result based on the client terminal user information carried in the first reservation request and the reservation object information corresponding to the first reservation request, wherein the first reservation result includes information about successful reservation corresponding to the first reservation request and the client terminal user information; and sends a reservation information update request to the transaction object server after the first reservation result is generated, wherein the reservation information update request is configured to request to update user information associated with the first reservation result from the default user information that was used when the second reservation request is sent, to the client terminal user information.

For example, according to the reservation requirement of the hotel, guest-related information needs to be carried in the second reservation request previously initiated by the platform server. In this case, the platform server may initiate a hotel reservation request using the default user information, and obtain successfully reserved hotel information as the reservation information of the initial inventory. After the first reservation request actually initiated by the client terminal user is received, a room provided for the client terminal user is selected from the previously reserved rooms, and a hotel reservation result generated using the real client terminal user information is returned to the client terminal. Then, the platform server may initiate an order information update request to the hotel management system to change the previously reserved default user information into the real client terminal user information.

For example, whether an inventory amount of the reservation object is lower than a set threshold is determined after the reservation information of the inventory is updated; and if the inventory amount of the reservation object is lower than the set threshold, inventory alarm information is pushed to a manager, which prompts the manager to select whether to replenish the inventory; or a reservation process is initiated to the transaction object server automatically. As such, the platform server ensures that the reservation information completed in advance is in a sufficient inventory state, thus meeting the reservation request initiated by the user in real time.

In S204b, if the reservation information of the inventory does not meet the first reservation request, the platform server sends the first reservation request to the transaction object server and receives the first reservation result fed back by the transaction object server.

Here, when the inventory is insufficient, for example, the client terminal requests reserving 2 standard rooms of a hotel and there is no or only one standard room in the inventory, in this case, the platform server may initiate a first reservation request to the transaction object server according to the conventional process.

In S205, the platform server feeds the first reservation result back to the client terminal.

Here, the first reservation result fed back to the client terminal by the platform server may be a reservation result directly generated by the platform server when the inventory meets the requirement, or may be a reservation result requested from the transaction object server and returned by the platform server when the inventory is insufficient. The client terminal receives the first reservation result returned by the server based on the reservation information of the inventory, and presents the first reservation result to the user.

In the above example embodiment, a platform server in advance initiated a reservation request to a transaction object server outside a system before a user actually initiates a reservation request to the platform server, and store an obtained reservation result as reservation information of an initial inventory. After a reservation request actually initiated by a client terminal is received, a reservation result corresponding to the actual reservation request of the user is returned to the client terminal based on the reservation information of the local inventory. As such, the platform server does not need to initiate a request to the transaction object server at the time when the request from the client terminal is received, and the client terminal obtains the reservation result returned by the platform server in time, thus improving the reservation efficiency and reservation success rate and then improving user experience.

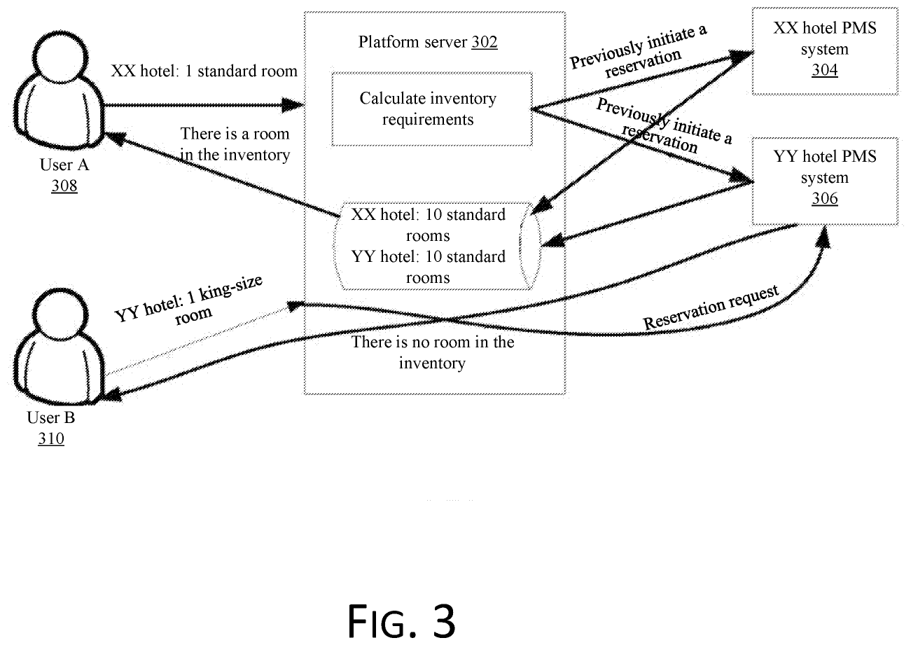

As shown in FIG. 3, a platform server 302 reserves 10 standard rooms in advance from XX hotel via XX hotel PMS system 304 and YY hotel via YY hotel PMS system 306 according to inventory requirement previously calculated. A user A 308 initiates a request for reserving a standard room of XX hotel subsequently, and in this case, the platform server 302 determines that the reservation request of the user A 308 is met according to the pre-stored inventory information, and then provides information about successful reservation of a standard room of XX hotel to the user A 308. Therefore, the user A 308 may acquire the information about successful reservation quickly. Subsequently, a user B 310 initiates a request for reserving a king-size room of YY hotel, and in this case, the platform server 302 determines that the reservation request of the user B 310 cannot be met according to the pre-stored inventory information, needs to send a reservation request to a YY hotel PMS system at that time and returns a reservation result fed by the YY hotel PMS system back to the user B 310. It is apparent that the reservation process of the user B 310 requires longer time than that of the user A.

In the actual implementation, in addition to the scenario of hotel reservation, the present disclosure is further applicable to any other scenarios that require the platform server to send a reservation request to the transaction object server to provide a reservation result for the client terminal user, such as flight ticket reservation and movie ticket reservation. In these scenarios, the platform server calculates in advance user requirements, in advance initiates a reservation request to a service provider outside the platform, and stores the requested reservation result as the reservation information of the inventory. Then, when the client terminal initiates a request actually, a relevant reservation result is provided for the client terminal based on the previously requested reservation information.

The present disclosure is further illustrated below through an example embodiment.

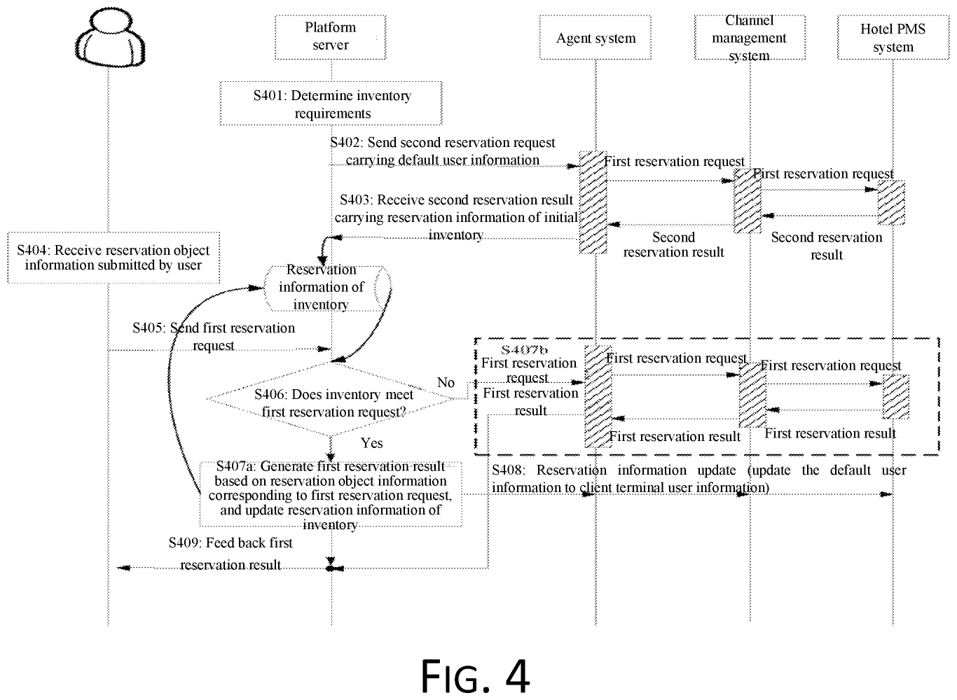

FIG. 4 is a flowchart of a transaction object reservation method according to an example embodiment of the present disclosure, including:

In S401, a platform server determines, according to historical reservation data, an inventory requirement in a future reservation time period for each transaction object server, wherein the historical reservation data includes reservation data of a reservation actually initiated by the user for the reservation object provided by the transaction object server, and the inventory requirement includes a total amount of requirements of various users for reservation objects provided by the transaction object server.

In an example implementation, the platform server may provide various reservation services (such as hotel reservation and flight ticket reservation) for users, and respectively count inventory requirements of each transaction object (such as a standard room and a king-size room) that may be provided by each transaction object service provider (such as XX chain hotel and YY chain hotel, and may also be a combination of a chain hotel and an agent) in each reservation service. For example, order data completed for each transaction object in a recent preset time length (e.g., one month) may be calculated, and inventory requirement information for the transaction object in a reservation time period (e.g., one day) is predicted based on the calculated order data. For example, a reservation number N of standard rooms of a chain hotel in a recent month is calculated according to stored order data of standard rooms of the chain hotel, and thus it may be predicted that the reservation number of standard rooms of the chain hotel is about N/30 each day. Therefore, the platform server may subsequently reserve N/30 standard rooms of the chain hotel in advance from 7:00 am each day.

The above prediction process is merely an example, and in an actual implementation, order data in a historical time period having an attribute identical to that of a reservation time period may be acquired first according to attribute information (e.g., whether it is a holiday, whether an event is held in a specific city, or the like) of the reservation time period, and order requirement information is predicted based on the order data. For example, if a reservation time period is in the May Day holiday, order data in May Day holidays in the recent 3 years may be acquired, and order requirement information of a request object is predicted based on the order data.

Here, the platform server generates a second reservation request based on a predicted inventory requirement of each transaction object in the reservation time period. Here, for each transaction object, the platform server may complete reservation of the transaction object in the reservation time period in one request. For example, it is predicted that the reservation requirement number of standard rooms of a chain hotel is N/30 each day, and the platform server may request reserving N/30 standard rooms of the chain hotel from a management system of the chain hotel in one reservation request. However, the platform server may also initiate multiple reservation requests for reserving N/30 standard rooms of the chain hotel, for example, one room is reserved in each request.

In an example implementation, the length of the above reservation time period may be used as one cycle, and the platform server may periodically initiate a second reservation request to obtain a second reservation result. For example, in the above example, the server may initiate a hotel reservation request to the outside of the system every morning to reserve the hotel room on the day.

In S402, the platform server sends the second reservation request carrying the default user information to the transaction object server according to the determined inventory requirement.

In an actual implementation, the platform server may also initiate a reservation cancellation request to the transaction object server according to the reservation request actually initiated by the client terminal when determining that there is a remaining unreserved transaction object in the reservation information of the inventory. For example, the platform server requests reserving 10 standard rooms of a chain hotel at 7:00 am, and finds that there are 5 remaining rooms that are not reserved at 6:00 pm. At this time, the platform server may initiate a request to cancel the reservation of the 5 rooms.

In S403, the platform server receives the second reservation result carrying the information about successful reservation and returned by the transaction object server, and uses such information as the reservation information of the initial inventory.

In S404, the client terminal receives reservation object information submitted by the user.

In S405, the client terminal sends the first reservation request carrying the reservation object information and the client terminal user information to the platform server based on the received reservation object information.

In S406, the platform server determines, according to the reservation object information in the first reservation request and the reservation information of the inventory, whether the reservation information of the inventory meets the first reservation request. If so, S407a is performed, and if not, S407b is performed.

In S407a, when the reservation information of the inventory meets the first reservation request, the platform server generates the first reservation result based on the reservation object information corresponding to the first reservation request and the client terminal user information, and updates the reservation information of the inventory. Then, S408 and S409 are performed.

In S408, a reservation information update request is sent to the transaction object server for requesting updating user information associated with the first reservation result from the default user information used when the second reservation request is sent to the client terminal user information.

In S407b, if the reservation information of the inventory does not meet the first reservation request, the platform server sends the first reservation request to the transaction object server and receives the first reservation result fed back by the transaction object server.

Here, the platform server initiates reservation based on the normal reservation process.

In S409, the platform server feeds the first reservation result back to the client terminal.

Here, the client terminal receives the first reservation result fed back by the platform server based on the reservation object information in the first reservation request and the reservation information of the inventory.

With the above example embodiment, a platform server may previously initiate a reservation request to a transaction object server outside a system before a user actually initiates a reservation request to the platform server, and store an obtained reservation result as reservation information of an initial inventory. After a reservation request actually initiated by a client terminal is received, a reservation result corresponding to the actual reservation request of the user is returned to the client terminal based on the reservation information of the local inventory. As such, the platform server does not need to initiate a request to the transaction object server at the time when the request from the client terminal is received, and the client terminal may obtain the reservation result returned by the platform server in time, thus improving the reservation efficiency and reservation success rate and then improving user experience.

Transaction object reservation system and apparatus corresponding to the transaction object reservation method are further provided in the example embodiments of the present disclosure. The principles for the system and apparatus to solve problems are similar to those of the transaction object reservation method according to the example embodiments of the present disclosure; therefore, reference may be made to the implementation of the method for implementations of the system and apparatus, and repeated parts are not elaborated here.

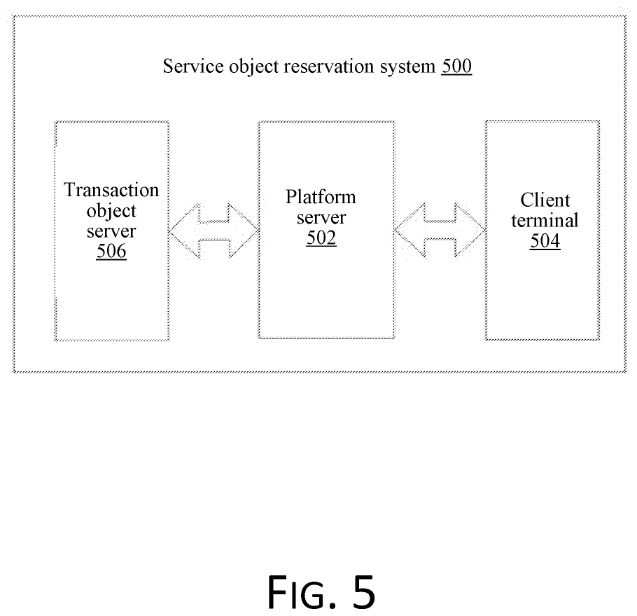

FIG. 5 is a schematic diagram of a transaction object reservation system 500 according to an example embodiment of the present disclosure, including:

a platform server 502 configured to receive a first reservation request carrying reservation object information and sent by a client terminal; determine, according to the reservation object information and reservation information of an inventory, whether the reservation information of the inventory meets the first reservation request, wherein the reservation information of the inventory is obtained by the platform server previously initiating a second reservation request carrying the reservation object information; if so, generate a first reservation result corresponding to the first reservation request; if not, send the first reservation request to a transaction object server to obtain a first reservation result; and feed the first reservation result back to the client terminal;

the client terminal 504 configured to receive the reservation object information submitted by a user, and send the first reservation request to the platform server based on the reservation object information; and receive the first reservation result fed back by the platform server based on the reservation object information in the first reservation request and the reservation information of the inventory; and

the transaction object server 506 configured to receive the second reservation request previously initiated by the platform server, and feed a second reservation result back to the platform server, wherein the second reservation result includes information about successful reservation corresponding to the second reservation request, serving as reservation information of an initial inventory of the platform server; and receive the first reservation request initiated by the user and sent by the platform server, and feed the first reservation result back to the platform server.

For example, the reservation object is a hotel room, the transaction object server is a hotel management server, and the reservation object information includes a name of the reserved hotel and a room type.

For example, the platform server 502 is configured to initiate the second reservation request according to the following steps:

determining, according to historical reservation data, an inventory requirement in a future reservation time period, wherein the historical reservation data includes reservation data of a reservation actually initiated by the user for the reservation object, and the inventory requirement includes a total amount of requirements of various users for reservation objects provided by the transaction object server; and

sending the second reservation request to the transaction object server according to the determined inventory requirement.

For example, client terminal user information is further carried in the first reservation request; and default user information is further carried in the second reservation request;

when the reservation information of the inventory meets the first reservation request, the platform server 502 is configured to generate the first reservation result according to the following step:

generating the first reservation result based on the client terminal user information carried in the first reservation request and the reservation object information corresponding to the first reservation request, wherein the first reservation result includes the information about successful reservation corresponding to the first reservation request and the client terminal user information; and

the platform server 502 is further configured to:

send a reservation information update request to the transaction object server after the first reservation result is generated, wherein the reservation information update request is configured to request to update user information associated with the first reservation result from the default user information used when the second reservation request is sent, to the client terminal user information; and

the transaction object server 506 is further configured to:

update, according to the reservation information update request, the stored user information associated with the first reservation result from the default user information to the client terminal user information.

For example, the platform server 502 is further configured to:

determine whether an inventory amount of the reservation object is less than a set threshold after the reservation information of the inventory is updated; and

if so, push inventory alarm information to a manager, to prompt the manager to select whether to replenish the inventory; or initiate a reservation process to the transaction object server automatically.

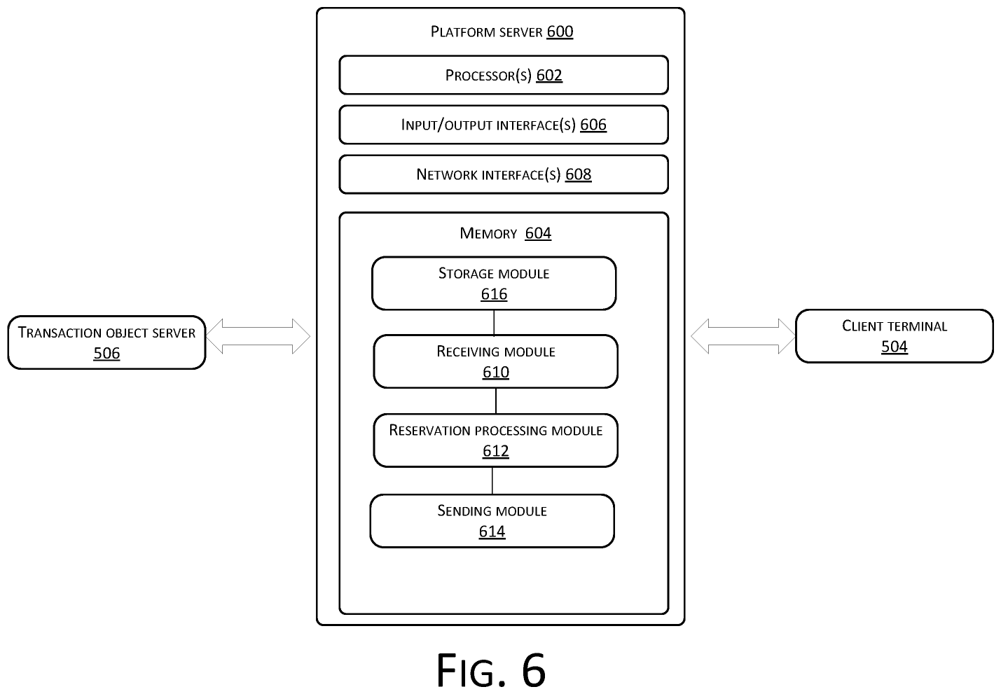

FIG. 6 is a schematic structural diagram of a platform server 600 according to an example embodiment of the present disclosure.

As shown in FIG. 6, the platform server 600 includes one or more processor(s) 602 or data processing unit(s) and memory 604. The platform server 600 may further include one or more input/output interface(s) 606 and one or more network interface(s) 608. The memory 604 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 604 may store therein a plurality of modules or units including:

a receiving module 610 configured to receive a first reservation request carrying reservation object information and sent by a client terminal 504;

a reservation processing module 612 configured to determine, according to the reservation object information in the first reservation request and reservation information of an inventory, whether the reservation information of the inventory meets the first reservation request, wherein the reservation information of the inventory includes information about successful reservation obtained after a second reservation request carrying the reservation object information is initiated to a transaction object server by a sending module 614 in advance; if the reservation information of the inventory meets the first reservation request, generate a first reservation result based on the reservation object information corresponding to the first reservation request; if the reservation information of the inventory does not meet the first reservation request, control the sending module 614 to send the first reservation request to the transaction object server 506, and obtain, by the receiving module 610, the first reservation result fed back by the transaction object server 506; and

the sending module 614 further configured to feed the first reservation result back to the client terminal 504.

For example, the reservation processing module 612 is configured to send the second reservation request according to the following steps:

determining, according to historical reservation data, an inventory requirement in a future reservation time period, wherein the historical reservation data includes reservation data of a reservation actually initiated by the user for the reservation object, and the inventory requirement includes a total amount of requirements of various users for reservation objects provided by the transaction object server; and

sending the second reservation request to the transaction object server according to the determined inventory requirement.

For example, client terminal user information is further carried in the first reservation request; and default user information is further carried in the second reservation request;

the reservation processing module 612 is configured to generate the first reservation result according to the following step:

generating the first reservation result based on the client terminal user information carried in the first reservation request and the reservation object information corresponding to the first reservation request, wherein the first reservation result includes the information about successful reservation corresponding to the first reservation request and the client terminal user information; and

the sending module 614 is further configured to:

send a reservation information update request to the transaction object server 506, wherein the reservation information update request is configured to request to update user information associated with the first reservation result from the default user information used when the second reservation request is sent, to the client terminal user information.

For example, the reservation processing module 612 is further configured to:

update the reservation information of the inventory after the first reservation result is generated based on the reservation object information corresponding to the first reservation request.

For example, the reservation processing module 612 is further configured to:

determine whether an inventory amount of the reservation object is lower than a set threshold after the reservation information of the inventory is updated; and if so, push inventory alarm information to a manager by the sending module 614, to prompt the manager to select whether to replenish the inventory; or initiate a reservation process to the transaction object server automatically.

For example, service provider identifier information is further carried in the first reservation request;

the platform server 600 further includes the following module stored on memory 604:

a storage module 616 configured to establish a mapping relationship between the obtained information about successful reservation and the service provider identifier information corresponding to the transaction object server after the sending module 614 in advance initiates the second reservation request carrying the reservation object information to the transaction object server, and store the mapping relationship as the reservation information of the inventory; and

the reservation processing module 612 is configured to determine whether the reservation information of the inventory meets the first reservation request according to the following steps:

searching the reservation information of the inventory for the information about successful reservation corresponding to the service provider identifier information according to the service provider identifier information carried in the first reservation request; and determining, according to the reservation object information in the first reservation request, whether the information about successful reservation searched out meets the first reservation request.

The platform server may previously initiate a reservation request to a transaction object server outside a system before a user actually initiates a reservation request to the platform server, and store an obtained reservation result as reservation information of an initial inventory. After a reservation request actually initiated by a client terminal is received, a reservation result corresponding to the actual reservation request of the user is returned to the client terminal based on the reservation information of the local inventory. As such, the platform server does not need to initiate a request to the transaction object server at the time when the request from the client terminal is received, and the client terminal may obtain the reservation result returned by the platform server in time, thus improving the reservation efficiency and reservation success rate and then improving user experience.

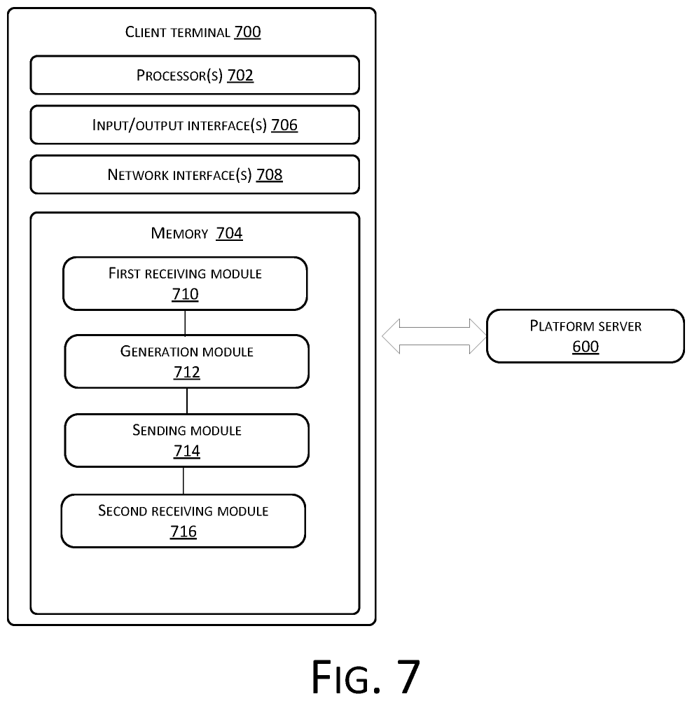

FIG. 7 is a schematic structural diagram of a client terminal 700 according to an example embodiment of the present disclosure.

As shown in FIG. 7, the client terminal 700 includes one or more processor(s) 702 or data processing unit(s) and memory 704. The client terminal 700 may further include one or more input/output interface(s) 706 and one or more network interface(s) 708. The memory 704 is an example of computer readable medium or media.

The memory 704 may store therein a plurality of modules or units including:

a first receiving module 710 configured to receive reservation object information submitted by a user;

a generation module 712 configured to generate a first reservation request carrying the reservation object information based on the reservation object information;

a sending module 714 configured to send the first reservation request; and

a second receiving module 716 configured to receive a first reservation result fed back by the platform server 600 according to the reservation object information in the first reservation request and reservation information of an inventory, wherein the reservation information of the inventory includes information about successful reservation obtained by the platform server 600 after previously initiating a second reservation request carrying the reservation object information to a transaction object server; and the first reservation result includes information about successful reservation corresponding to the first reservation request.

With the above client terminal, a reservation result returned by the platform server 600 based on the previously stored reservation information may be returned to the user in time, thus improving the reservation efficiency and reservation success rate and then improving user experience.

Those skilled in the art should understand that the example embodiments of the present disclosure may be provided as a method, a system, or a computer program product. Therefore, the present disclosure may be implemented in the form of a complete hardware example embodiment, a complete software example embodiment, or an example embodiment combining software and hardware. Moreover, the present disclosure may be in the form of a computer program product implemented on one or more computer usable storage media (including, but are not limited to, a magnetic disk memory, a CD-ROM, an optical memory and the like) including computer usable program codes.

The present disclosure is described with reference to flowcharts and/or block diagrams of the method, apparatus (system) and computer program product according to the example embodiments of the present disclosure. It should be understood that a computer program instruction may be used to implement each process and/or block in the flowcharts and/or block diagrams and combinations of processes and/or blocks in the flowcharts and/or block diagrams. These computer program instructions may be provided to a general-purpose computer, a special-purpose computer, an embedded processor, or a processor of another programmable data processing device to generate a machine, so that the instructions executed by the computer or the processor of another programmable data processing device generate an apparatus configured to implement a specified function in one or more processes in the flowcharts and/or in one or more blocks in the block diagrams.

These computer program instructions may also be stored in a computer readable memory that may guide a computer or another programmable data processing device to work in a particular manner, such that the instructions stored in the computer readable memory generate an article of manufacture that includes an instruction apparatus. The instruction apparatus implements a function specified in one or more processes in the flowcharts and/or in one or more blocks in the block diagrams.

These computer program instructions may also be loaded onto a computer or another programmable data processing device, such that a series of operation steps are performed on the computer or another programmable device, thus generating computer-implemented processing. Therefore, the instructions executed on the computer or another programmable device provide steps for implementing a function specified in one or more processes in the flowcharts and/or in one or more blocks in the block diagrams.

Preferred example embodiments of the present disclosure have been described; however, those skilled in the art may make other variations and modifications on these example embodiments once knowing basic creative concepts. Therefore, the appended claims are intended to be construed as incorporating the preferred example embodiments and all variations and modifications falling within the scope of the present disclosure.

It is apparent that those skilled in the art may make various changes and variations to the present disclosure without departing from the spirit and scope of the present disclosure. As such, if these modifications and variations of the present disclosure fall within the scope of the claims of the present disclosure and equivalent technologies thereof, the present disclosure is also intended to incorporate these modifications and variations.

The present disclosure may further be understood with clauses as follows.

Clause 1. A transaction object reservation system comprising:

a platform server configured to receive a first reservation request carrying reservation object information and sent by a client terminal; determine, according to the reservation object information and reservation information of an inventory, whether the reservation information of the inventory meets the first reservation request, wherein the reservation information of the inventory is obtained by the platform server previously initiating a second reservation request carrying the reservation object information; when the reservation information of the inventory meets the first reservation request, generate a first reservation result corresponding to the first reservation request; when the reservation information of the inventory does not meet the first reservation request, send the first reservation request to a transaction object server to obtain the first reservation result; and feed the first reservation result back to the client terminal;

the client terminal configured to receive the reservation object information submitted by a user, and send the first reservation request to the platform server based on the reservation object information; and receive the first reservation result fed back by the platform server based on the reservation object information in the first reservation request and the reservation information of the inventory; and

the transaction object server configured to receive the second reservation request previously initiated by the platform server, and feed a second reservation result back to the platform server, wherein the second reservation result comprises information about successful reservation corresponding to the second reservation request, which serves as reservation information of an initial inventory of the platform server; and receive the first reservation request initiated by the user and sent by the platform server, and feed the first reservation result back to the platform server.

Clause 2. The system of clause 1, wherein:

the reservation object is a hotel room;

the transaction object server is a hotel management server, and

the reservation object information comprises a name of the hotel and a room type.

Clause 3. The system of clause 1, wherein the platform server initiates the second reservation request according to the following steps:

determining, according to historical reservation data, an inventory requirement in a future reservation time period, wherein the historical reservation data comprises reservation data of a reservation actually initiated by the user for the reservation object, and the inventory requirement comprises a total amount of requirements of various users for reservation objects provided by the transaction object server; and

sending the second reservation request to the transaction object server according to the determined inventory requirement.

Clause 4. The system of clause 1, wherein:

the first reservation request further carries client terminal user information and the second reservation request further carries default user information;

when the reservation information of the inventory meets the first reservation request, the platform server is further configured to generate the first reservation result according to the following step:
generating the first reservation result based on the client terminal user information carried in the first reservation request and the reservation object information corresponding to the first reservation request, wherein the first reservation result comprises information about successful reservation corresponding to the first reservation request and the client terminal user information; the platform server is further configured to:

send a reservation information update request to the transaction object server after the first reservation result is generated, wherein the reservation information update request is configured to request to update user information associated with the first reservation result from the default user information used when the second reservation request is sent to the client terminal user information; and

the transaction object server is further configured to:

update, according to the reservation information update request, the stored user information associated with the first reservation result from the default user information to the client terminal user information.

Clause 5. The system of clause 1, wherein the platform server is further configured to:

determine whether an inventory amount of the reservation object is less than a set threshold after the reservation information of the inventory is updated; and

when the inventory amount of the reservation object is less than the set threshold, push inventory alarm information to a manager to prompt the manager to select whether to replenish the inventory; or initiate a reservation process to the transaction object server automatically.

Clause 6. A transaction object reservation method comprising:

receiving, by a platform server, a first reservation request carrying reservation object information and sent by a client terminal;

determining, according to the reservation object information in the first reservation request and reservation information of an inventory, whether the reservation information of the inventory meets the first reservation request, wherein the reservation information of the inventory comprises information about successful reservation obtained by the platform server previously initiating a second reservation request carrying the reservation object information to a transaction object server;

when the reservation information of the inventory meets the first reservation request, generating a first reservation result based on the reservation object information corresponding to the first reservation request; or when the reservation information of the inventory does not meet the first reservation request, sending the first reservation request to the transaction object server and receiving the first reservation result fed back by the transaction object server; and feeding the first reservation result back to the client terminal.

Clause 7. The method of clause 6, wherein the previously initiating, by the platform server, the second reservation request to the transaction object server comprises:

determining, by the platform server according to historical reservation data, an inventory requirement in a future reservation time period, wherein the historical reservation data comprises reservation data of a reservation actually initiated by the user for the reservation object, and the inventory requirement comprises a total amount of requirements of various users for reservation objects provided by the transaction object server; and

sending the second reservation request to the transaction object server according to the determined inventory requirement.

Clause 8. The method of clause 6, wherein:

the first reservation request further carries client terminal user information and the second reservation request further carries default user information;

when the reservation information of the inventory meets the first reservation request, the generating the first reservation result based on the reservation object information corresponding to the first reservation request comprises:
generating the first reservation result based on the client terminal user information carried in the first reservation request and the reservation object information corresponding to the first reservation request, wherein the first reservation result comprises information about successful reservation corresponding to the first reservation request and the client terminal user information; and after generating the first reservation result, the method further comprises:

sending a reservation information update request to the transaction object server, wherein the reservation information update request is configured to request to update user information associated with the first reservation result from the default user information used when the second reservation request is sent to the client terminal user information.

Clause 9. The method of clause 6, wherein after generating the first reservation result based on the reservation object information corresponding to the first reservation request, the method further comprises:

updating the reservation information of the inventory.

Clause 10. The method of clause 9, wherein after the updating the reservation information of the inventory, the method further comprises:

determining whether an inventory amount of the reservation object is less than a set threshold; and

when the inventory amount of the reservation object is less than the set threshold, pushing alarm information to a manager to prompt the manager to select whether to replenish the inventory; or initiating a reservation process to the transaction object server automatically.

Clause 11. The method of clause 6, wherein:

the first reservation request further carries service provider identifier information;

after previously initiating, by the platform server, the second reservation request carrying the reservation object information to the transaction object server, the method further comprises:
establishing a mapping relationship between the obtained information about successful reservation and the service provider identifier information corresponding to the transaction object server, and storing the mapping relationship as the reservation information of the inventory; and

the determining, according to the reservation object information in the first reservation request and reservation information of the inventory, whether the reservation information of the inventory meets the first reservation request comprises:
searching the reservation information of the inventory for the information about successful reservation corresponding to the service provider identifier information according to the service provider identifier information carried in the first reservation request; and
determining, according to the reservation object information in the first reservation request, whether the searched information about successful reservation meets the first reservation request.

Clause 12. A user request processing method comprising:

receiving, by a client terminal, reservation object information submitted by a user;

sending a first reservation request carrying the reservation object information to a platform server; and

receiving a first reservation result fed back by the platform server according to the reservation object information in the first reservation request and reservation information of an inventory, wherein the reservation information of the inventory comprises information about successful reservation obtained by the platform server previously initiating a second reservation request carrying the reservation object information to a transaction object server; and the first reservation result comprises information about successful reservation corresponding to the first reservation request.

Clause 13. A platform server comprising:

a receiving module configured to receive a first reservation request carrying reservation object information and sent by a client terminal;

a reservation processing module configured to determine, according to the reservation object information in the first reservation request and reservation information of an inventory, whether the reservation information of the inventory meets the first reservation request; when the reservation information of the inventory meets the first reservation request, generate a first reservation result based on the reservation object information corresponding to the first reservation request; and when the reservation information of the inventory does not meet the first reservation request, control a sending module to send the first reservation request to a transaction object server, and obtain, by the receiving module, the first reservation result fed back by the transaction object server; and

the sending module further configured to feed the first reservation result back to the client terminal,

wherein the reservation information of the inventory comprises information about successful reservation obtained after a second reservation request carrying the reservation object information previously initiated to the transaction object server by the sending module.

Clause 14. The platform server of clause 13, wherein the reservation processing module is further configured to send the second reservation request according to the following steps:

determining, according to historical reservation data, an inventory requirement in a future reservation time period, wherein the historical reservation data comprises reservation data of a reservation actually initiated by the user for the reservation object, the inventory requirement comprising a total amount of requirements of various users for reservation objects provided by the transaction object server; and

sending the second reservation request to the transaction object server according to the determined inventory requirement.

Clause 15. The platform server of clause 13, wherein:

the first reservation request further carries client terminal user information and the second reservation request further carries default user information;

the reservation processing module is configured to generate the first reservation result according to the following step:
generating the first reservation result based on the client terminal user information carried in the first reservation request and the reservation object information corresponding to the first reservation request, wherein the first reservation result comprises information about successful reservation corresponding to the first reservation request and the client terminal user information; and the sending module is further configured to:

send a reservation information update request to the transaction object server, wherein the reservation information update request is configured to request to update user information associated with the first reservation result from the default user information used when the second reservation request is sent to the client terminal user information.

Clause 16. The platform server of clause 13, wherein the reservation processing module is further configured to:

update the reservation information of the inventory after the first reservation result is generated based on the reservation object information corresponding to the first reservation request.

Clause 17. The platform server of clause 16, wherein the reservation processing module is further configured to:

determine whether an inventory amount of the reservation object is lower than a set threshold after the reservation information of the inventory is updated; and when the inventory amount of the reservation object is lower than the set threshold, push inventory alarm information to a manager by the sending module to prompt the manager to select whether to replenish the inventory; or initiate a reservation process to the transaction object server automatically.

Clause 18. The platform server of clause 13, wherein:

the first reservation request further carries service provider identifier information;

the platform server further comprises:

a storage module configured to establish a mapping relationship between the obtained information about successful reservation and the service provider identifier information corresponding to the transaction object server after the sending module in advance initiates the second reservation request carrying the reservation object information to the transaction object server, and store the mapping relationship as the reservation information of the inventory; and

the reservation processing module further configured to determine whether the reservation information of the inventory meets the first reservation request according to the following steps:

searching the reservation information of the inventory for the information about successful reservation corresponding to the service provider identifier information according to the service provider identifier information carried in the first reservation request; and determining, according to the reservation object information in the first reservation request, whether the information about successful reservation searched out meets the first reservation request.

Clause 19. A client terminal comprising:

a first receiving module configured to receive reservation object information submitted by a user;

a generation module configured to generate a first reservation request carrying the reservation object information based on the reservation object information;

a sending module configured to send the first reservation request; and

a second receiving module configured to receive a first reservation result fed back by the platform server according to the reservation object information in the first reservation request and reservation information of an inventory, wherein the reservation information of the inventory comprises information about successful reservation obtained by the platform server previously initiating a second reservation request carrying the reservation object information to a transaction object server; and the first reservation result comprises information about successful reservation corresponding to the first reservation request.

What is claimed is:

1. A system comprising:
a platform server that:
receives a first reservation request carrying reservation object information of a reservation object and sent by a client terminal;
determines, according to the reservation object information and reservation information of an inventory, whether the reservation information of the inventory meets the first reservation request, wherein the reservation information of the inventory is obtained by the platform server previously initiating a second reservation request carrying the reservation object information;
in response to determining that the reservation information of the inventory meets the first reservation request, generates a first reservation result corresponding to the first reservation request;
in response to determining that the reservation information of the inventory does not meet the first reservation request, sends the first reservation request to a transaction object server to obtain the first reservation result; and
feeds the first reservation result back to the client terminal.

2. The system of claim 1, further comprising:
the client terminal that:
receives the reservation object information submitted by a user;
sends the first reservation request to the platform server based on the reservation object information; and
receives the first reservation result fed back by the platform server based on the reservation object information in the first reservation request and the reservation information of the inventory.

3. The system of claim 2, further comprising:
the transaction object server that:
receives the second reservation request previously initiated by the platform server;
feeds a second reservation result back to the platform server, wherein the second reservation result comprises information about successful reservation corresponding to the second reservation request, which serves as reservation information of an initial inventory of the platform server;
receives the first reservation request; and
feeds the first reservation result back to the platform server.

4. The system of claim 1, wherein:
the reservation object is a hotel room;
the transaction object server is a hotel management server, and
the reservation object information comprises a name of the hotel and a room type.

5. The system of claim 1, wherein the platform server initiates the second reservation request according to the following steps:
determining, according to historical reservation data, an inventory requirement in a future reservation time period, the inventory requirement comprises a total amount of requirements of various users for reservation objects provided by the transaction object server; and
sending the second reservation request to the transaction object server according to the determined inventory requirement.

6. The system of claim 5, wherein the historical reservation data comprises reservation data of a reservation actually initiated by the user for the reservation object.

7. The system of claim 1, wherein:
the first reservation request further carries client terminal user information and the second reservation request further carries default user information; and
in response to determining that the reservation information of the inventory meets the first reservation request, the platform server is further configured to generate the first reservation result according to the following step:
generating the first reservation result based on the client terminal user information carried in the first reservation request and the reservation object information corresponding to the first reservation request, wherein the first reservation result comprises information about successful reservation corresponding to the first reservation request and the client terminal user information.

8. The system of claim 7, wherein the platform server further:
sends a reservation information update request to the transaction object server after the first reservation result is generated, wherein the reservation information update request requests to update user information associated with the first reservation result from the default user information used in response to determining that the second reservation request is sent to the client terminal user information.

9. The system of claim 8, wherein the transaction object server further:
updates, according to the reservation information update request, the stored user information associated with the first reservation result from the default user information to the client terminal user information.

10. The system of claim 1, wherein the platform server further:
determines whether an inventory amount of the reservation object is less than a set threshold after the reservation information of the inventory is updated; and
in response to determining that the inventory amount of the reservation object is less than the set threshold, pushes inventory alarm information to a manager to prompt the manager to select whether to replenish the inventory, or initiates a reservation process to the transaction object server automatically.

11. A method comprising:
receiving, by a platform server, a first reservation request carrying reservation object information and sent by a client terminal;
determining, according to the reservation object information in the first reservation request and reservation information of an inventory, whether the reservation information of the inventory meets the first reservation request, wherein the reservation information of the inventory comprises information about successful reservation obtained by the platform server previously initiating a second reservation request carrying the reservation object information to a transaction object server;
in response to determining that the reservation information of the inventory meets the first reservation request, generating a first reservation result based on the reservation object information corresponding to the first reservation request; or in response to determining that the reservation information of the inventory does not meet the first reservation request, sending the first reservation request to the transaction object server and receiving the first reservation result fed back by the transaction object server; and
feeding the first reservation result back to the client terminal.

12. The method of claim 11, wherein the previously initiating, by the platform server, the second reservation request to the transaction object server comprises:
determining, by the platform server according to historical reservation data, an inventory requirement in a future reservation time period, the inventory requirement comprises a total amount of requirements of various users for reservation objects provided by the transaction object server; and
sending the second reservation request to the transaction object server according to the determined inventory requirement.

13. The method of claim 11, wherein:
the first reservation request further carries client terminal user information and the second reservation request further carries default user information; and
in response to determining that the reservation information of the inventory meets the first reservation request, the generating the first reservation result based on the reservation object information corresponding to the first reservation request comprises:
generating the first reservation result based on the client terminal user information carried in the first reservation request and the reservation object information corresponding to the first reservation request, wherein the first reservation result comprises information about successful reservation corresponding to the first reservation request and the client terminal user information.

14. The method of claim 13, further comprising:
after generating the first reservation result, sending a reservation information update request to the transaction object server, wherein the reservation information update request requests to update user information associated with the first reservation result from the default user information used in response to determining that the second reservation request is sent to the client terminal user information.

15. The method of claim 11, further comprising:
after the generating the first reservation result based on the reservation object information corresponding to the first reservation request, updating the reservation information of the inventory.

16. The method of claim 15, further comprising:
after the updating the reservation information of the inventory, determining whether an inventory amount of the reservation object is less than a set threshold; and
in response to determining that the inventory amount of the reservation object is less than the set threshold, pushing alarm information to a manager to prompt the manager to select whether to replenish the inventory, or initiating a reservation process to the transaction object server automatically.

17. The method of claim 11, wherein:
the first reservation request further carries service provider identifier information; and
after previously initiating, by the platform server, the second reservation request carrying the reservation object information to the transaction object server, the method further comprises:
establishing a mapping relationship between the obtained information about successful reservation and the service provider identifier information corresponding to the transaction object server, and storing the mapping relationship as the reservation information of the inventory.

18. The method of claim 17, wherein the determining, according to the reservation object information in the first reservation request and reservation information of the inventory, whether the reservation information of the inventory meets the first reservation request comprises:
searching the reservation information of the inventory for the information about successful reservation corresponding to the service provider identifier information according to the service provider identifier information carried in the first reservation request; and
determining, according to the reservation object information in the first reservation request, whether the searched information about successful reservation meets the first reservation request.

19. One or more memories stored thereon computer readable instructions that, when executed by one or more processors, cause the one or more processors to perform acts comprising:
receiving, by a platform server, a first reservation request carrying reservation object information and sent by a client terminal;
determining, according to the reservation object information in the first reservation request and reservation information of an inventory, whether the reservation information of the inventory meets the first reservation request, wherein the reservation information of the inventory comprises information about successful reservation obtained by the platform server previously initiating a second reservation request carrying the reservation object information to a transaction object server;
in response to determining that the reservation information of the inventory meets the first reservation request, generating a first reservation result based on the reservation object information corresponding to the first reservation request; and
feeding the first reservation result back to the client terminal.

20. The one or more memories of claim 19, further comprising:
in response to determining that the reservation information of the inventory does not meet the first reservation request, sending the first reservation request to the transaction object server and receiving the first reservation result fed back by the transaction object server
